(19) United States
(12) Patent Application Publication
(10) Pub. No.: US 2002/0099541 A1
(43) Pub. Date: Jul. 25, 2002

(54) Method and apparatus for voiced speech excitation function determination and non-acoustic assisted feature extraction

(76) Inventor: Gregory C. Burnett, San Francisco, CA (US)

Correspondence Address: PERKINS COIE LLP, P.O. BOX 2168, MENLO PARK, CA, 94026, US

(21) Appl. No.: 09/990,847

(22) Filed: Nov. 21, 2001

Related U.S. Application Data
(60) Provisional application No. 60/252,220, filed on Nov. 21, 2000.
(60) Provisional application No. 60/253,963, filed on Nov. 29, 2000.
(60) Provisional application No. 60/253,967, filed on Nov. 29, 2000.

(51) Int. Cl. G10L 21/00; G10L 19/12

(52) U.S. Cl. 704/223

(57) ABSTRACT

A method and apparatus are provided for producing a human voiced speech excitation function. The movement (position versus time) of a tracheal wall is determined using an electromagnetic sensor or equivalent, and the position is translated to pressure by determining the times of largest change in the movement waveform using a derivative, or differential, of the movement waveform. Pulses of various amplitude and width are placed at these times, and the result is shown to contain the same frequency information as the movement signal, although it can be described with considerably fewer parameters.

### RELATED APPLICATIONS

This application claims the benefit of U.S. Patent Application No. 60/252,220 filed Nov. 21, 2000, 60/253,963 and 60/253,967 both filed Nov. 29, 2000, and U.S. Ser. No. 09/905,361 filed Jul. 12, 2001, all of which are incorporated herein by reference in their entirety.

### TECHNICAL FIELD

The disclosed embodiments relate to speech signal processing methods and systems.

### BACKGROUND

In studies of the interaction of electromagnetic (EM) waves with human tissue, it has been determined that when EM waves were transmitted in the proximity of the glottis (the airspace between the vocal folds, commonly known as the vocal cords) during voiced speech, tracheal wall motion could be detected. See Burnett, Gregory C. (1999), “The Physiological Basis of Glottal Electromagnetic Micropower Sensors and Their Use in Defining an Excitation Function for the Human Vocal Tract”; Ph.D. Thesis, University of California at Davis. This motion is caused by the opening and closing of the vocal folds that occurs as voiced speech is produced. It was determined that a voltage representation of this motion could be effectively used as a voiced excitation function for human speech. The excitation function is the precursor to normal speech—it is the change in pressure due to the opening and closing of the vocal folds before the pressure is shaped by human articulators (such as the tongue, lips, nasal cavities, and others) to make acoustic sounds defined as speech. The excitation function is related to voiced speech as wax is to a candle. The excitation function and the wax are both the raw products, which are formed into speech and a candle, respectively, by a human operator.

In typical acoustic-only systems, the excitation function has been approximated using several different methods. It is sometimes assumed to be white noise, sometimes a single pulse, and sometimes a series of pulses that occur every glottal cycle (the glottal cycle is defined to be the time between vocal fold closures, as the closure is the event that begins the production of speech). Whatever the method, the result is just an approximation to the actual excitation function, as there have been no tools (with the possible exception of the electroglottographs (EGG) that measure vocal fold contact area and can only be used in a clinical application) with which to characterize the excitation function. See, for example, one or more of the following: Baer, T; Gore, J C; Gracco, L C and Nye, P W, “Analysis of vocal tract shape and dimensions using magnetic resonance imaging: Vowels,” J. Acoust. Soc. Am. 1991 V90 (2), 799-828; Titze, I R, “A four-parameter model of the glottis and vocal fold contact area,” Speech Communication 8 (1989) 191-201; Childers, D. G.; Hicks, D. M.; Moore, G. P. and Alsaka Y. A., “A model for vocal fold vibratory motion, contact area, and the electroglottogram.” J. Acoust. Soc. Am. 1986 V80 (5), 1309-1320; Titze, I. R., “Parameterization of the glottal area, glottal flow, and vocal fold contact area,” J. Acoust. Soc. Am. 1984 V75 (2), 570-580; Rothenberg, M. and Zahorian, S., “Nonlinear inverse filtering techniques for estimating the glottal area waveform,” J. Acoust. Soc. Am.1977, Vol. 61, No. 4, 1063-1071; Rothenberg, M., “A new inverse filtering technique for deriving the glottal airflow waveform during voicing,” J. Acoust. Soc. Am. 1973, Vol. 53, No. 6, 1632-1645; Flanagan, J. L., Ishizaka, K., and Shipley, K. L., “Synthesis of speech from a dynamic model of the vocal cords and tract,” The Bell System Technical Journal, Vol. 54, No. 3, March 1975; Cranen, B. and Boves, L., “Pressure measurements during speech production using semiconductor miniature pressure transducers: Impact on models for speech production,” J. Acoust. Soc. Am., Vol. 77, No. 4 (1985), 1543-1551; Koike, Y. and Hirano, M., “Glottal-area time function and subglottal-pressure variation,” J. Acoust. Soc. Am., Vol. 54, No. 6 (1973),1618-1627; Lofqvist, A., Carlborg, B., and Kitzing, P., “Initial validation of an indirect measure of subglottal pressure during vowels,” J. Acoust. Soc. Am. Vol. 72, No. 2 (1982), 633-665; Ishizaka, K., Matsudaira, M., and Kaneko, T., “Input acoustic-impedance measurement of the subglottal system,” J. Acoust. Soc. Am., Vol. 60, No. 1 (1976), 190-197; and Childers, D. G. and Bae, K. S., “Detection of laryngeal function using speech and electroglottographic data,” IEEE Trans. On Biomechanical Engineering, Vol. 39, No. 1 (1992), 19-25.

Theoretically, the excitation function should be a smooth negative pulse when the vocal folds close and a wider positive pulse when the vocal folds open. This is because the vocal folds close more rapidly than they open. These pulses contain many frequencies and excite the vocal tract into resonance. In turn, the pulses are modified by the shape of the vocal tract and its articulators into the sounds humans interpret as speech. The pulses are not the only constituents of the excitation function, but they do contain the vast majority of the energy, and an acceptable excitation function can be constructed with only the pulses.

### BRIEF DESCRIPTION OF THE FIGURES

FIG. 1 is a block diagram of a speech signal processing system 100, under an embodiment.

FIG. 2 is a block diagram of a speech signal processing system 200, under one alternate embodiment.

FIG. 3 is a flow diagram for generating a pulsed excitation (PE) function, under the embodiment of FIG. 2, using glottal-area electromagnetic micropower sensor (GEMS) data.

FIG. 4 is a plot of GEMS output for normal tracheal motion.

FIG. 5 is a plot of a first derivative and a second derivative of the corrected GEMS signal of FIG. 4, under the embodiment of FIG. 3.

FIG. 6 is a plot of a corrected GEMS signal and a resulting PE function, under the embodiment of FIG. 3.

FIG. 7 is a power spectral density plot of a GEMS signal and a GEMS-derived PE function.

FIG. 8 is a power spectral density plot of an unfiltered PE function.

FIG. 9 is a comparison plot of transfer functions as calculated using the GEMS signal and PE function as the excitation function versus a transfer function calculated using linear predictive coding (LPC), which does not use an excitation function.

FIG. 10 is a plot of corrected GEMS position versus time data for tracheal position along with simple harmonic oscillator (SHO) position versus time data using a PE function of the GEMS, under an embodiment.

FIG. 11 is a flow diagram for calculating simple harmonic oscillator-pulsed excitation (SHO-PE) parameters, under an embodiment, using GEMS and/or acoustic data and a Kalman filter.

FIG. 12 is a flow diagram for determining SHO parameters, under an alternate embodiment, using a Kalman Filter in the absence of GEMS signal information.

FIG. 13 is a flow diagram for a zero-crossing algorithm to calculate pitch period, under an embodiment.

In the figures, the same reference numbers identify identical or substantially similar elements or acts.

Any headings provided herein are for convenience only and do not necessarily affect the scope or meaning of the claimed invention.

### DETAILED DESCRIPTION

Using an electromagnetic sensor similar to the one described by Burnett, Gregory C. (1999), “The Physiological Basis of Glottal Electromagnetic Micropower Sensors and Their Use in Defining an Excitation Function for the Human Vocal Tract”; Ph.D. Thesis, University of California at Davis (the “Burnett reference”), a determination can be made as to when the vocal folds open and close. This information supports a highly accurate approximation of the actual pulsed excitation (PE) function of the voicing system under embodiments of the invention described below. A determination is then made of the state of the vocal tract and the speech at the time of calculation using the PE function approximation. This information is described by using one or more feature vectors that describe the pitch, frequency content of the speech, transfer function of the vocal tract, and many others that can be calculated using standard signal processing techniques. However, with an accurate excitation function, it is possible to determine these parameters much more precisely, as well as calculate ones not available previously.

A method is described below for calculating a human voiced speech excitation function. The movement (position versus time) of a tracheal wall is determined using an electromagnetic sensor or equivalent, and the position is translated to pressure by determining the times of largest change in the movement waveform using a derivative, or differential, of the movement waveform. Pulses of various amplitude and width are placed at these times, and the result is shown to contain the same frequency information as the movement signal, although it can be described with considerably fewer parameters. The excitation function so produced is shown to lead to a better model of the vocal tract than is typically available using standard acoustic-only processing. The excitation function is also useful for calculating a variety of speech parameters with great accuracy, some of which are not available with conventional technology.

Under another embodiment, the system recovers the original position versus time waveform information by passing the PE function through a simple harmonic oscillator (SHO) model. Adaptive algorithms in the prior art, such as the Kalman filter, can be used to select the optimal values for the pulse amplitude and width and the parameters of the SHO model.

The following description provides specific details for a thorough understanding of, and enabling description for, embodiments of the invention. However, one skilled in the art will understand that the invention may be practiced without these details. In other instances, well known structures and functions have not been shown or described in detail to avoid unnecessarily obscuring the description of the embodiments of the invention.

Unless described otherwise below, the construction and operation of the various blocks shown in the Figures are of conventional design. As a result, such blocks need not be described in further detail herein, because they will be understood by those skilled in the relevant art. Such further detail is omitted for brevity and so as not to obscure the detailed description of the invention. Any modifications necessary to the blocks in the Figures (or other embodiments) can be readily made by one skilled in the relevant art based on the detailed description provided herein.

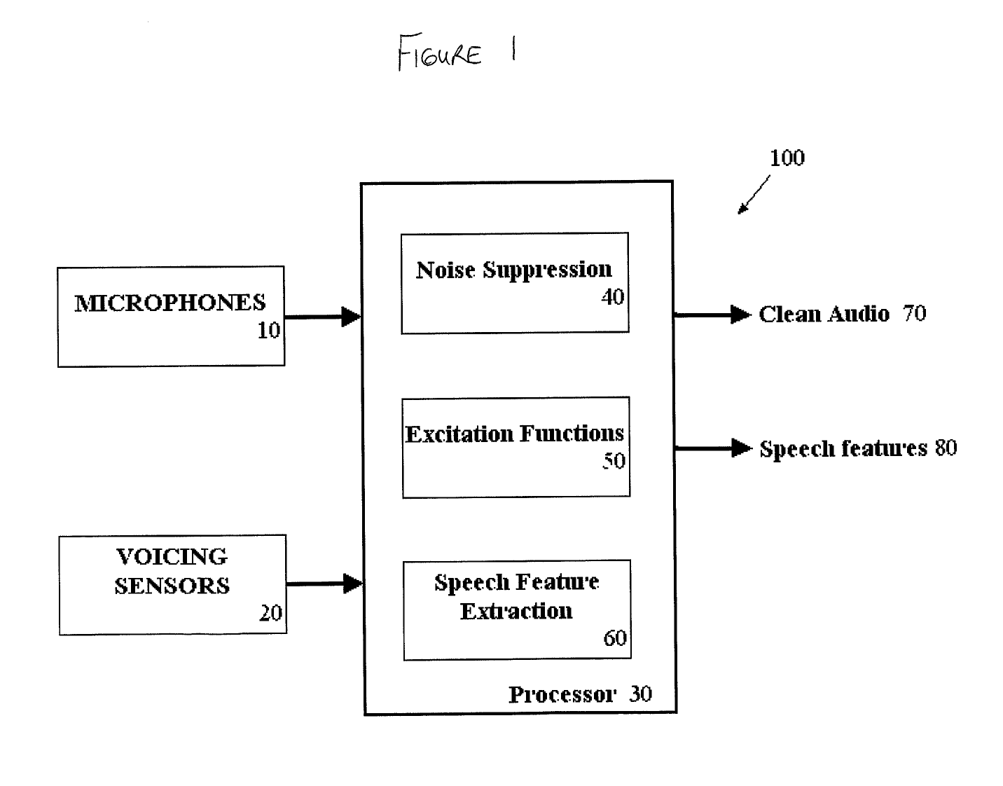

FIG. 1 is a block diagram of a speech signal processing system 100, under an embodiment. The system 100 includes microphones 10 and sensors 20 that provide signals to at least one processor 30. The processor 30 includes algorithms 40-60 for processing signals from the microphones 10 and sensors 20. The processing includes, but is not limited to, suppressing noise 40 and generating excitation functions 50 and speech feature extraction 60. The system 100 outputs cleaned speech signals or audio 70, as well as relevant speech features 80.

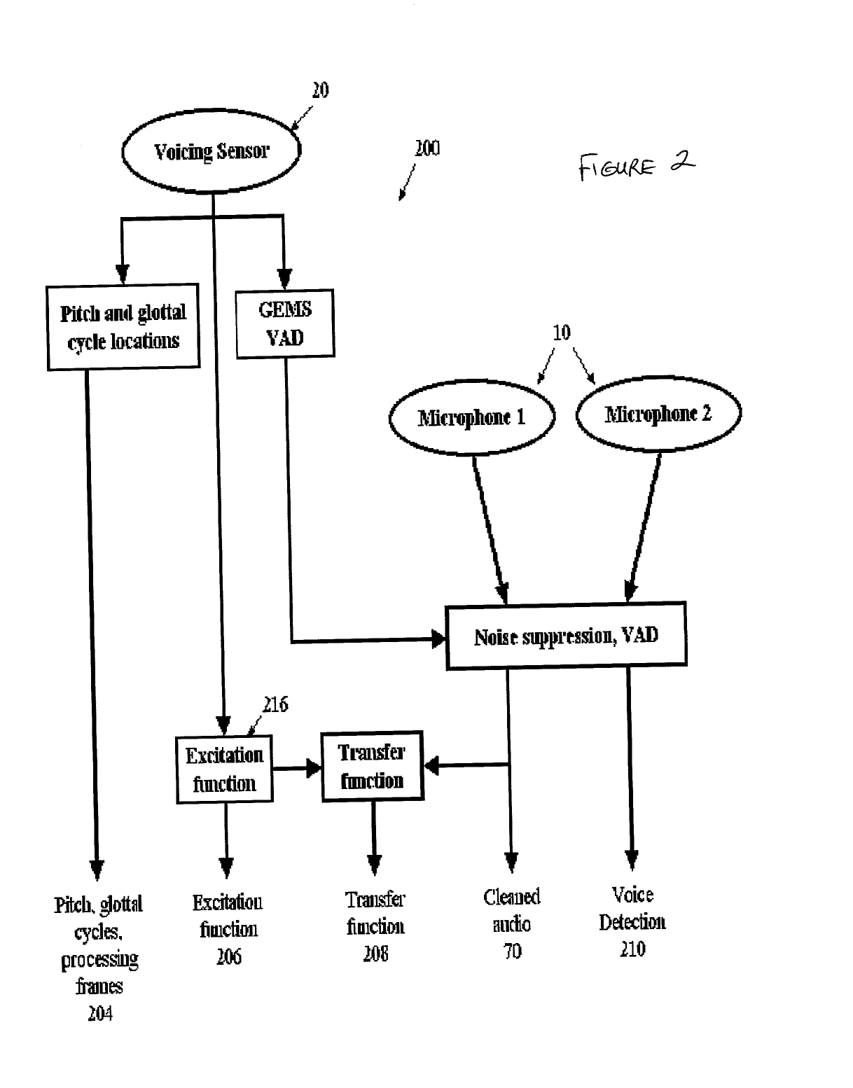

FIG. 2 is a block diagram of a speech signal processing system 200, under one alternate embodiment. The system 200 includes a glottal-area electromagnetic micropower sensor (GEMS) 20 and microphones 10, including microphone 1 and microphone 2. The GEMS sensor 20 provides signals or information used by the system to generate information including pitch, processing frames, and glottal cycle information 204, and excitation functions 206. The microphones 10 provide signals that the system uses to produce clean audio 70 and voicing/unvoicing information 210. Transfer functions 208 are produced using information from both the GEMS sensor 20 and the cleaned audio 70.

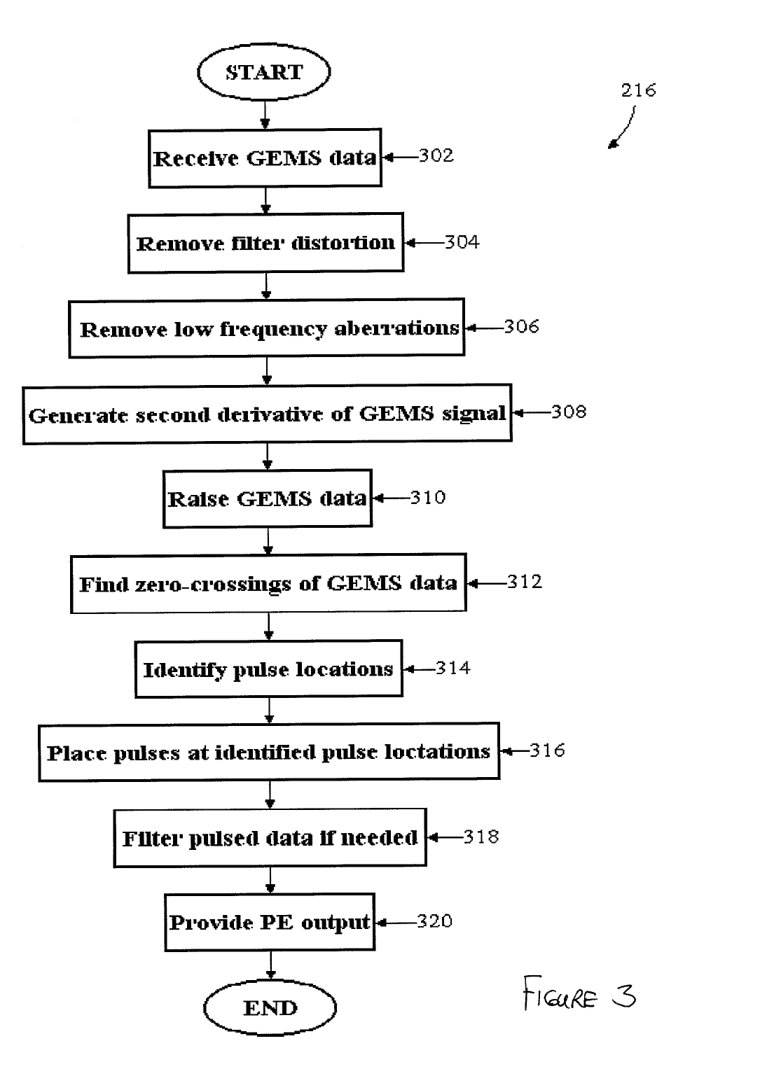

The excitation functions 206 are generated, in an embodiment, in the excitation function subsystem 216 or area of the software, firmware, or circuitry. FIG. 3 is a flow diagram 216 for generating a pulsed excitation (PE) function 206, under the embodiment of FIG. 2, using GEMS data. The system receives GEMS data at block 302, and removes any filter distortion from the GEMS signal due to the analog filters, at block 304, using a digital acausal inverse filter. While this embodiment uses GEMS data, alternate embodiments might receive data from other EM sensors.

A 50 Hz highpass distortion-free digital filter refilters the GEMS signals to remove any low frequency aberrations, at block 306. The system takes the difference of the resulting GEMS signal twice, at block 308, in order to simulate a second derivative of the GEMS signal. The resulting signal, referred to herein as rd2, is shifted one sample to the right for correct time alignment, but is not so limited.

Continuing at block 310, approximately 5 to 10% of the expected peak-to-peak signal of the rd2 signal is added to the inverse filtered GEMS data to raise it slightly above a zero level. This facilitates the system in running a zero-crossing algorithm, at block 312, to identify all possible zero crossings of the raised GEMS data from block 310. The system checks the identified zero crossings to make sure they are correct by looking for isolated crossings, crossings with improper periods, etc. In the areas of the identified zero crossings (approximately 5 to 10% of the corresponding period), the system searches the rd2 signal for zero crossings, at block 312. When found near an original GEMS positive-to-negative zero crossing, the system identifies and labels the nearest sample of rd2 data as a negative pulse point, at block 314; furthermore, when near a negative-to-positive zero crossing, the system labels the nearest sample of rd2 data as a positive pulse point. Note that at times there may not be a detectable positive pulse, especially if the vocal folds are not sealing well. There will always be a negative pulse if there is voicing.

Upon determining the pulse points, the system places pulses having the desired amplitude and width at the determined pulse points, at block 316. These may be determined through trial and error or through an adaptive process such as a Kalman filter. The closing pulse is defined to be negative and the opening pulse positive to correlate with supraglottal pressure. The resulting pulse data can optionally be low-pass filtered (smooth), at block 318, to an appropriate frequency so that frequency content close to the Nyquist frequency does not cause any problems. The system provides the PE function output, at block 320. This method of calculating a pulsed excitation (PE) function is now described in further detail.

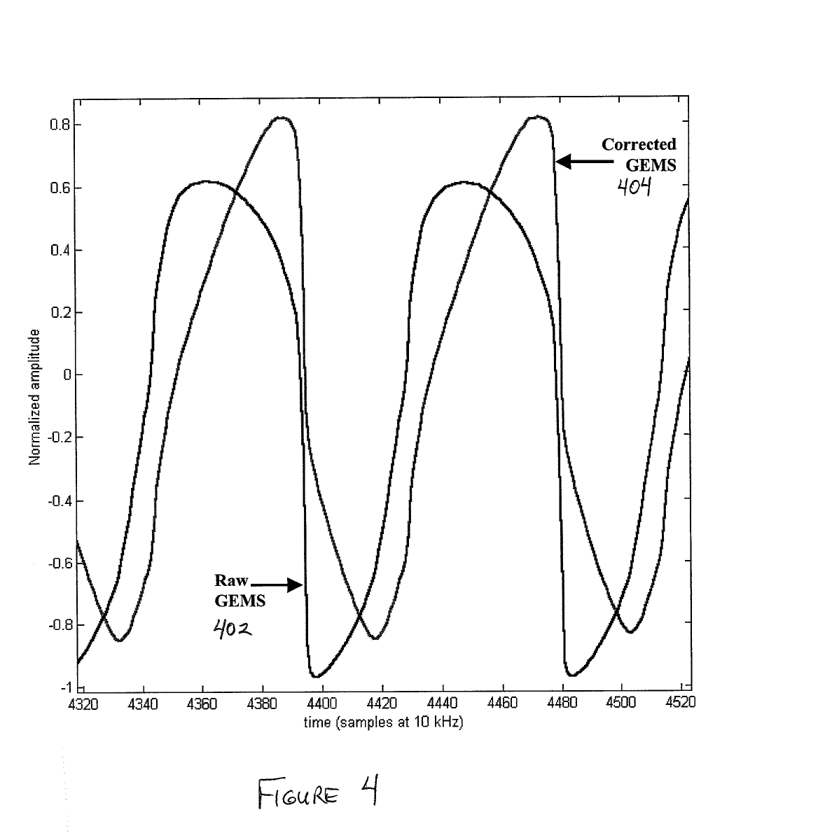

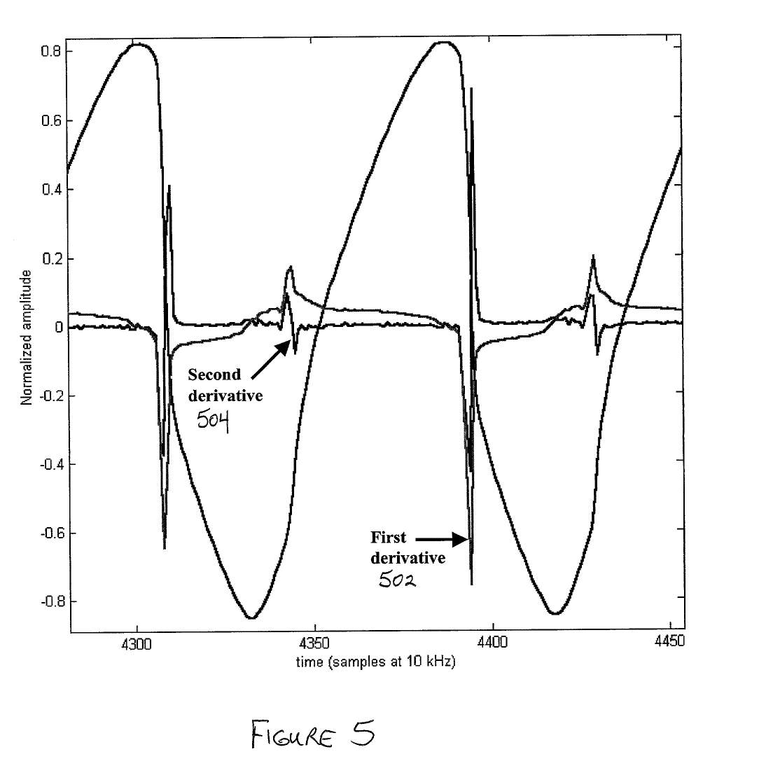

In an embodiment, the EM sensor is used to determine the relative position versus time of a tracheal wall, and as such is referred to herein as a GEMS. Any tracheal wall (front, back, sides) can be measured, although the back wall is simpler to detect due to its larger amplitude of vibration owing to less damping from the trachea's cartilage support members. The relative motion can be determined using other means, such as accelerometers, without adversely affecting the accuracy of the result, as long as the motion determination is accurate and reliable. FIG. 4 is a plot of GEMS output 402 for normal tracheal motion, under the embodiment of FIG. 2. FIG. 5 is a plot of a first derivative 502 and a second derivative 504 of the corrected GEMS signal 404 of FIG. 4. It is important that any distortion of the position versus time signal that has occurred due to filtering or other processes be removed as completely as possible, so that an accurate determination of both pulse positions may be made. However, the filter-distorted signal may be used to determine the negative (closing) pulse locations with good accuracy, but the locations of the positive (opening) pulses can be adversely affected. A plot of the corrected position data 404 represents the position versus time of the posterior wall of the trachea, and is therefore able to locate both pulse positions more accurately. The procedure for correction is known in the art, and described in detail in the Burnett reference.

The tracheal position data is then used to determine the time when the vocal folds open and close. The closure is more important, as that generates most of the excitation energy, but the opening does contribute and can be an important part of the excitation function. The method used to correlate the GEMS signal with the opening and closing times of the vocal folds is described in detail in the Burnett reference, and involves the use of the GEMS, laryngoscopes, and high-speed (3000 frames a second) video capture. For clarity, a brief discussion is now presented as to how the subglottal pressure changes induced by the opening and closing of the vocal folds affect the trachea.

As the vocal folds close, the resistance of the vocal folds to airflow rises rapidly, approximately as the fourth power of the glottal area (again, the glottis is the airspace between the vocal folds). The subglottal pressure therefore rises very rapidly in less than a millisecond. This rapid pressure rise causes a “water hammer” effect on the surrounding tissue, causing the position of the tracheal wall to change very rapidly. This is quite easy to detect given either GEMS signal 402 and 404 shown in FIG. 4, and the exact position is easy to calculate using the second derivative 504 of the GEMS signal shown in FIG. 5. When the vocal folds close, the pressure rises rapidly, and the position of the tracheal wall changes very rapidly causing the first derivative 502 of the GEMS signal to peak. A peak in the first derivative means a zero crossing in the second derivative, and it is this zero crossing location which is determined through linear interpolation to be the point at which the pulse takes place.

With reference to FIG. 5, the first derivative 502 and second derivative 504 are approximated by simple differences to speed processing. In this case, the simple difference is a relatively accurate derivative estimate, as the sample time (approximately 0.1 milliseconds) is normally much less than a glottal cycle (approximately 8 to 10 milliseconds). The second derivative 504 is offset to the right one sample to correct for the time loss due to the two difference operations. Although the second derivative zero crossings may appear to occur at about the same time as the regular GEMS zero crossings, this is not always the case, especially for the opening pulse and small GEMS signals. The second derivative zero crossings provide information regarding when the largest change in position occurs, which is a far more accurate method of locating the events of interest.

The opening of the vocal folds may be found in a similar manner. The opening of the vocal folds occurs more slowly, so the change in pressure is not as rapid and the effect on the trachea not as strong. However, most of the time a significant change in the gradient of the GEMS can be detected and the location of the opening pulse determined in the same manner as the closing pulse. An opening pulse is not always present especially for weakly voiced and breathy voiced speech. Comparison of the derived pulse locations and high-speed photography of the vocal folds in operation provided in the Burnett reference shows excellent agreement.

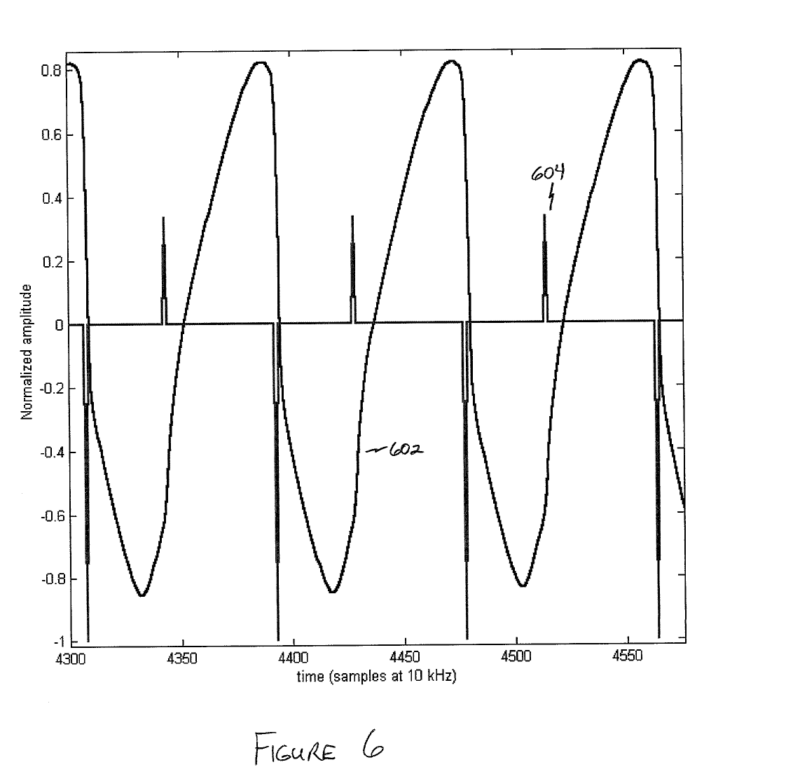

The system now constructs the pulsed excitation (PE) function using the knowledge of where the pulses should be located. FIG. 6 is a plot of a corrected GEMS signal 602 and a resulting PE function 604, under the embodiment of FIG. 3. It is clear that the pulse placements can be determined automatically given the opening and closing times. In this example, the amplitude of the main pulse (at fold closure) is assigned an amplitude of negative three and a width of one, while the secondary pulse (at fold opening) is assigned an amplitude of one and a width of one. Experiments have shown that reproducing the acoustic waveform can be done quite well with only the closing pulse, but both are included here for completeness. The closing pulse is negative and the opening pulse is positive to correspond with the supraglottal pressure pulses, which are defined as the actual excitation function of the system. With the GEMS, a determination is made as to when the subglottal pressure pulses occur, but these times are the same as for the supraglottal pulses.

The relative amplitudes and widths of the pulses may also be changed at will to better match the acoustic output. For example, the secondary opening pulse may be widened to three samples to reflect the slower opening pressure pulse. However, experiments have shown that the vocoding of speech is relatively insensitive to the location and width of the positive pulse, so its characteristics do not seem to be that critical. However, it is clear that the amplitude and width of the pulses can be changed as needed to better match the output of human speech.

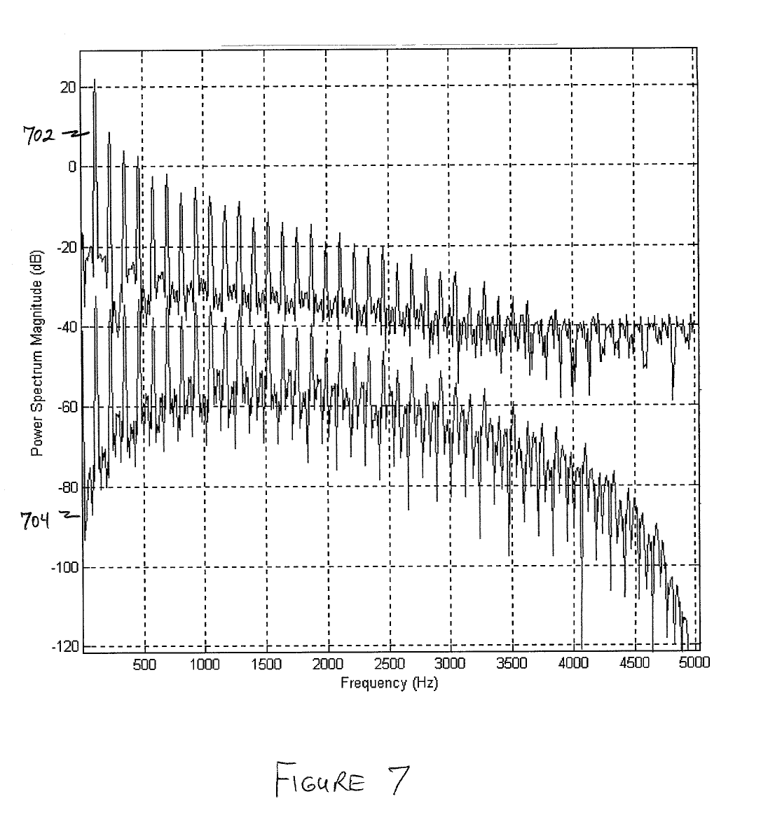

FIG. 7 is a power spectral density plot of a GEMS signal 702 and a GEMS-derived PE function 704. In general, these power spectral density plots 702 and 704 show that the GEMS signal and the PE function contain the same information, just in different forms. These plots 702 and 704 show that both signals contain the same fundamental frequency (at about 118 Hz) and the same overtones up to about 3500 Hz, where the SNR gets too low for a meaningful comparison. Since the two signals 702 and 704 have the same frequency content, and they only differ in amplitude, they are equally useful in calculating a transfer function.

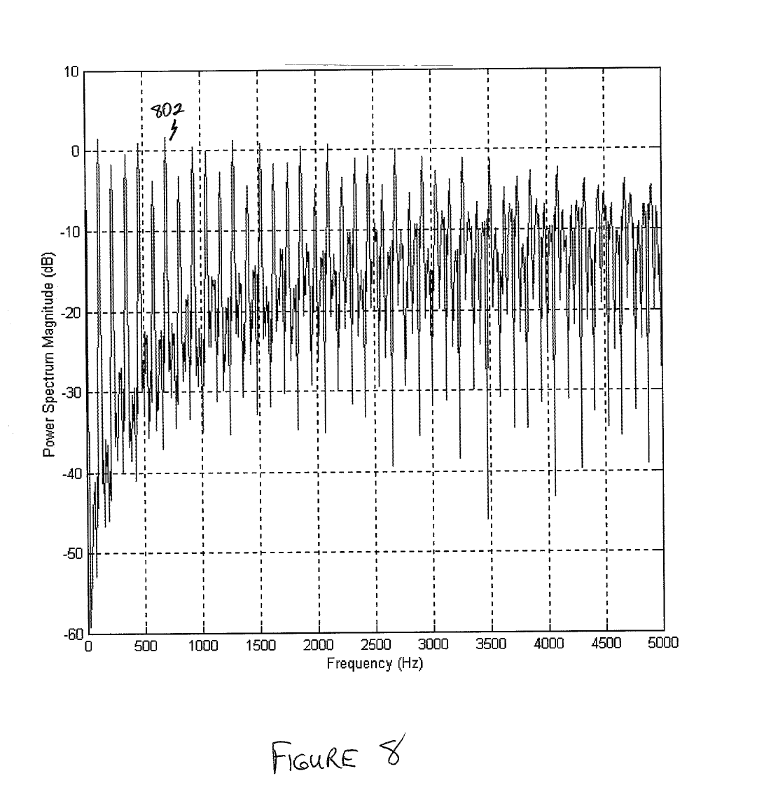

It is noted that the PE function from which the power spectral density signal 704 was generated was lowpass filtered to facilitate comparison with that of the GEMS signal 702. FIG. 8 is a power spectral density plot 802 of an unfiltered PE function. The spectral content is flat, so that all frequencies are excited equally, a characteristic of the excitation function.

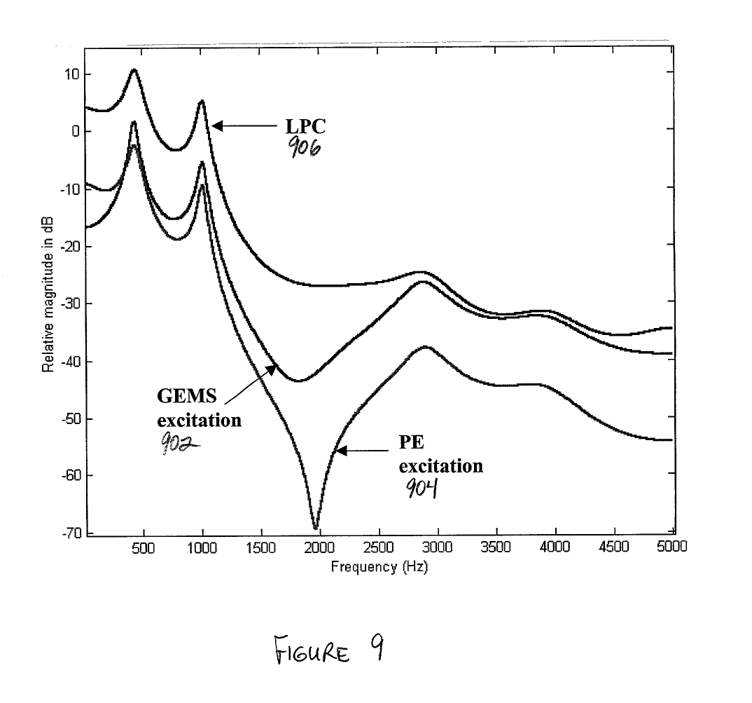

To demonstrate the effectiveness and usefulness of the excitation function, FIG. 9 is a comparison plot of transfer functions as calculated using the GEMS 902 and PE function 904 as the excitation function versus a transfer function calculated using linear predictive coding (LPC) 906, which does not use an excitation function. All methods use 12 poles to model the data, and the GEMS and PE calculations use 4zeros as well, since the excitation function was available. The acoustic data is approximately 0.1 seconds of a long “0” sampled at approximately 10 kHz. It is clear that all three methods agree on the location of the peaks of the transfer function, which are defined by the poles, but the LPC method completely misses the zero at 1800-1900 Hz. That is because without the excitation function, it is not possible to model the zeros of a system. The PE and GEMS methods disagree slightly on the location of the zero, but that is not significant because, by definition, there is little acoustic energy at a zero and so there is invariably some variation in the calculation.

It is believed that this is, at present, the only way to calculate an accurate and meaningful excitation function. With the exception of the EGG, all current excitation function calculation methods use estimations and approximations that are not accurate enough to replicate natural sounding speech. The EGG, which measures vocal fold contact area, does not measure the effects of the pressure changes directly. It is therefore left to the experimenter to calculate probable airflow or pressure changes given the change in vocal fold contact area. The EM sensors allow direct measurement of the movement that is directly coupled to the pressure change, thereby supporting an accurate determination of the pulsed excitation function under the embodiments described herein.

It is noted that GEMS is not strictly necessary for calculating the PE as described above. Signals having similar features have been successfully captured from the side of the neck and jaw. Once calibrated to tracheal motion using a GEMS sensor, these signals can be used to at least detect the closing pulse, which is sufficient for most purposes.

The PE function is well suited for use in vocoding. It is capable of extremely low transmission bandwidth due to its simple construction, made possible due to the accuracy in locating the pulse locations. However, there are times when a translation is needed from the PE function back to a GEMS-like signal for processing on the receiving end. It may be that the only known signal is from some place other than the trachea, such as the jaw, and there is a need to construct the position versus time plot of the trachea of the user. It is also useful as a method by which the tracheal properties can be modeled.

By using the GEMS signal or a similar signal, the PE can be constructed with the use of a simple harmonic oscillator (SHO) model to reconstruct the GEMS signal to a high degree of accuracy. Once the SHO parameters for a person have been established they shouldn't change significantly, even with a change in vocal intensity, as they are not under voluntary control. They represent the physical properties of the trachea and may be useful in an application such as speaker verification. The SHO parameters can be determined using a Kalman filter or any similar algorithm.

It has been found that using a SHO system to model the trachea is quite effective. The parameters of the SHO include mass, elasticity, and damping. The SHO is widely used to model oscillators, and is a good approximation if the system being modeled is linear or only slightly nonlinear. In this case, linearity is assumed for normal speech, as the estimated motions of the trachea are quite small (˜1 millimeter) and the tracheal walls quite flexible.

As an example, a PE function was calculated using corrected data from a GEMS device and then the PE was processed using a rough SHO model in order to construct a similar GEMS signal. Since the motion of something that should behave similar to a SHO (the tracheal wall) is being measured, there is an expectation that if the model is sufficiently accurate, the simulated position versus time of the SHO-PE should be close to the measured position versus time derived from the GEMS.

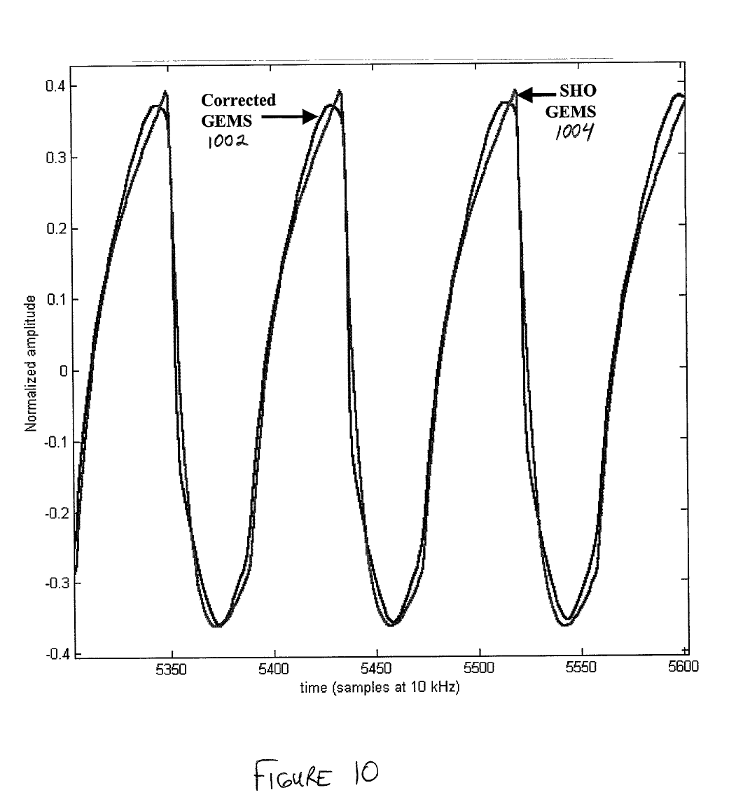

FIG. 10 is a plot of corrected GEMS position versus time data 1002 for tracheal position along with SHO position versus time data 1004 using a PE function of the GEMS, under an embodiment. They are very similar, and should be even better when the parameters are matched more closely using an adaptive algorithm such as a Kalman filter given the GEMS and an acoustic output. The small differences are likely due to small SHO parameter mismatches and incorrect PE function widths and amplitudes. The PE function closing pulse had an amplitude of −3, the opening pulse an amplitude of 1, and both had a width of 1; no effort was made to optimize the amplitudes and widths. For the purposes of this application, the SHO parameters were arrived at by trial and error. Still, the fit of the SHO-PE position data to the actual position is quite striking, and demonstrates the validity of the PE and the SHO model.

It is noted that the GEMS and the acoustic recordings are not synchronized in time. The GEMS operates at about 300,000,000 meters per second, whereas the acoustic information plods along at about 330 meters per second. Thus, once the sound is produced at the vocal folds, it takes about 0.5 milliseconds (or 5 samples at a 10 kHz sampling rate) for the sound to exit the mouth and enter a microphone 2 centimeters away from the mouth. The GEMS, on the other hand, only takes approximately 140 picoseconds to detect the motion of the trachea—for all intents, it is instantaneous. Thus the GEMS data must be retarded by about 0.5 milliseconds in order to match well with the acoustic data. The difference is not a large one, but it is present and should be compensated for if maximum accuracy is desired.

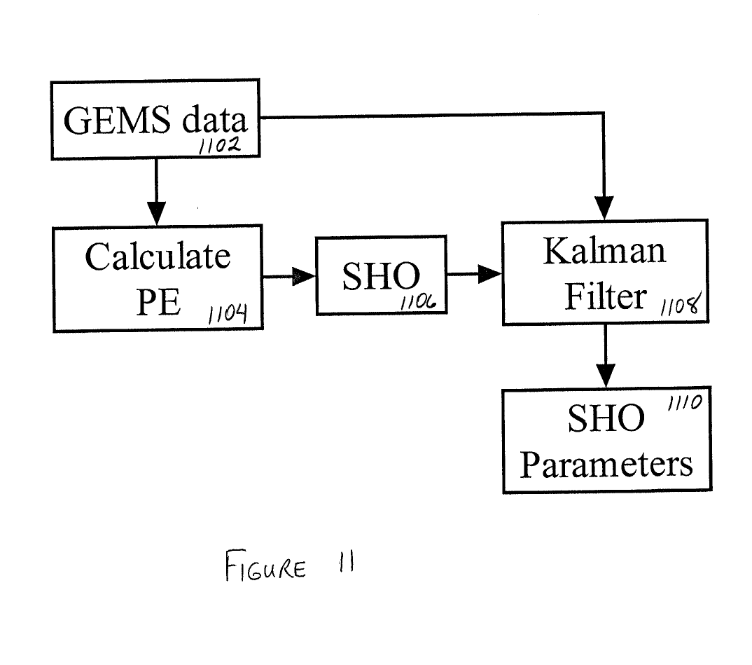

FIG. 11 is a flow diagram for calculating simple harmonic oscillator-pulsed excitation (SHO-PE) parameters, under an embodiment, using GEMS and/or acoustic data and a Kalman filter. The GEMS data 1102 is provided to a subroutine that calculates 1104 the PE as described and shown with reference to FIG. 6. This is used by a SHO model 1106 with “best guess” parameters that gives the Kalman Filter 1108 a starting point. The Kalman Filter 1 108 takes the output from the SHO model 1106 and the GEMS data 1102 and determines the SHO parameters 1110, including correct value of the mass, elasticity, and damping. These parameters 1110 are then used for that person. The Kalman Filter 1108 is not required, and any signal processing method that does system identification will suffice.

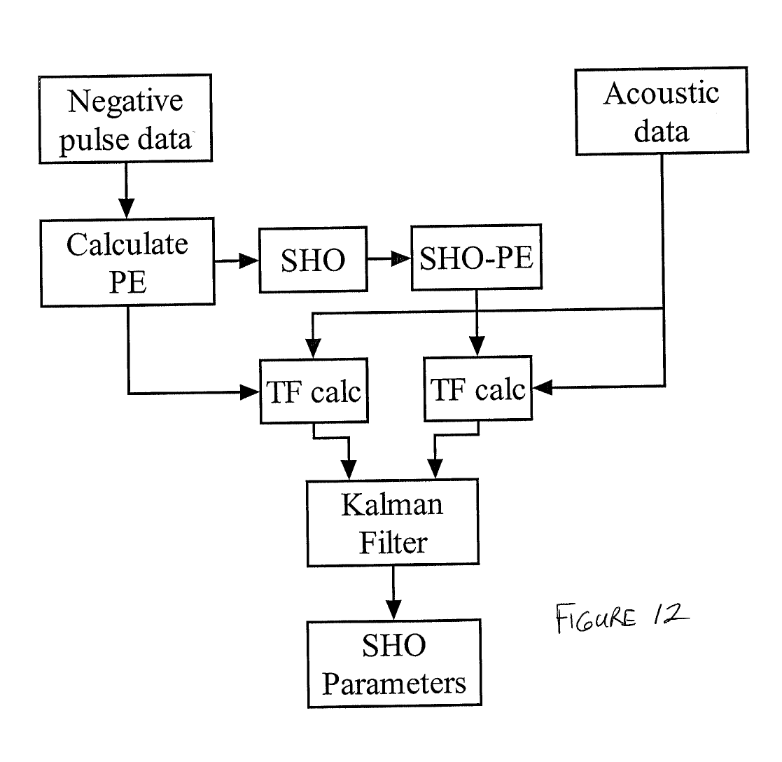

FIG. 12 is a flow diagram for determining SHO parameters, under an alternate embodiment, using a Kalman Filter in the absence of GEMS signal information. It is assumed for this example that some electromagnetic information is available, perhaps from the jaw or side of the neck, that allows a determination of the negative pulse locations. Also, this example assumes that the correct excitation is the PE, and compares the transfer functions calculated using the PE to those of the SHO-PE. The acoustic data is used for these transfer function calculations. As the PE and the SHO-PE have different frequency amplitudes, the slopes of the transfer functions will not be the same, but the locations of the resonances and ant-resonances (formants and zeros) should be the same. Thus the Kalman Filter may use these locations to train the system to return the correct SHO parameters.

There are numerous speech features that may be calculated using the unique information in the GEMS and other EM sensors. Some are new, and some are simply improvements of older features, where more accuracy is possible through the use of the EM sensors. These features include, but are not limited to, voiced excitation functions, voicing state, pitch period, transfer functions, and tracheal parameters. A description of each of these features along with a corresponding implementation now follows.

The voiced excitation is a signal that corresponds to the air pressure that drives speech production. It consists of pressure pulses that correspond to the opening and closing of the vocal folds. This is the “source” in the canonical source-filter model of speech. Typical speech processing derives an approximation to this based on inverse filtering of an audio signal after it has been processed to determine its linear predictive coefficients (LPC). It is a poor approximation, as it is essentially the residual of the LPC modeling process, not a true excitation. As for implementation, the voiced excitation functions are described fully above.

Regarding voicing state, the non-acoustic nature of the EM sensors makes them perfect for voicing determination. The EM sensors yield large signal-to-noise ratios when detecting vibrations associated with speech, and allow the building of a very accurate voiced-speech activity detector (VAD). This VAD is unaffected by acoustic noise and therefore its accuracy does not depend on the signal to noise ratio (SNR) of the captured acoustic speech. It supports accurate processing of data that is heavily contaminated by noise.

Determining the occurrence of voicing is simple with EM sensors because the signal from the EM sensor generally has a high (>20 dB) SNR that is phoneme independent. One method of determining voicing is to use the energy or power of the EM signal compared to an absolute threshold. For example, with a maximum sensor output of 1V, a normal norm-2 measure would be around 0.2. The norm-2 calculation of a vector x uses the formula

$${norm}_{2} ( x ) = \frac{1}{n} \sqrt{{\sum }_{i}^{n} {x}_{i}^{2}} .$$

For normal background noise, the norm-2 would be around 0.02, and a voicing check could easily be made by determining if the norm-2 of the data of interest (usually 8-10 millisecond windows) is above 0.05.

Pitch period is the inverse of the fundamental frequency at which the vocal cords vibrate during voiced speech. It may be measured directly from the GEMS signal as the time between fold closures. Thus, the pitch may be determined for every glottal cycle, resulting in unprecedented accuracy. Existing acoustic-only speech processing estimates the pitch from long-term averaging of features in the audio signal. This is either a highly inaccurate or a somewhat inaccurate and time-consuming process; in addition it is sensitive to acoustic noise. The GEMS-derived pitch is extremely fast and physiologically accurate.

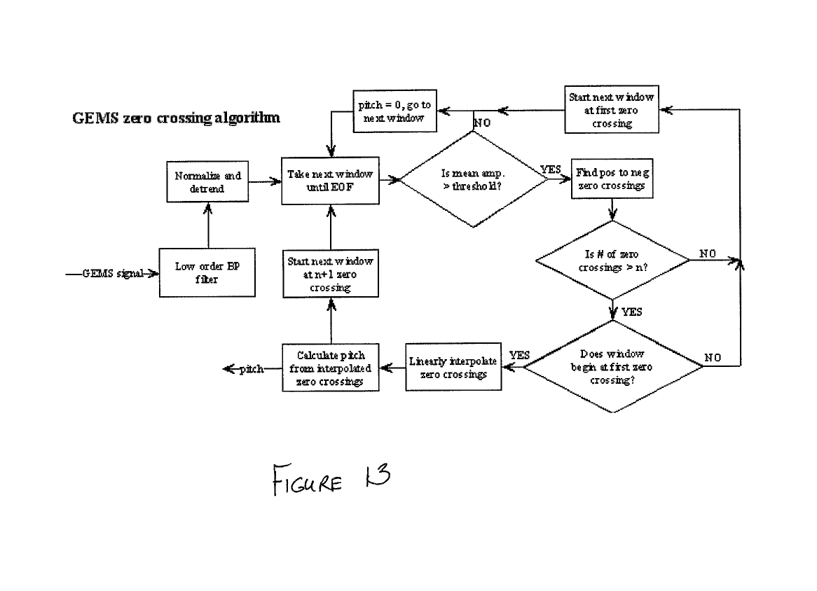

FIG. 13 is a flow diagram for a zero-crossing algorithm to calculate pitch period, under an embodiment. In general, this implementation finds and identifies the positive-to-negative zero crossings of the GEMS signal, which denote the closing of the vocal folds.

In the standard model of speech production, the throat, mouth, nose, and other articulators act as a filter to shape the excitation function into the desired sound. The transfer function represents that filter. If the excitation function is filtered by the transfer function, the resulting signal (if the excitation and transfer function are good approximations) will be very close to the original speech. Typical prior art speech systems usually determine their transfer functions based on liner predictive coding (LPC) algorithms, which use no excitation function signal at all and cannot fully model the speech.

In determining the transfer function, the excitation function and output are calculated or recorded using the methods described above. Then, standard signal processing system identification techniques know in the are may be applied to the results to determine the transfer function. Mathematically, in the z domain

$$TF ( z ) = \frac{O ( z )}{EF ( z )} ,$$

where O(z) is the z-transform of the output and EF(z) is the z-transform of the excitation function. The signal processing system identification techniques used include least-mean squared (LMS) adaptive algorithms, power spectral division, and many others.

Regarding tracheal parameters, the PE function is determined as described above and then used with an algorithm like a Kalman filter and SHO model (or similar models) to model the tracheal wall properties. These parameters could be used as part of an identification algorithm or used to reproduce the position versus time data from one or more EM sensors. Implementations are described above with reference to FIGS. 11 and 12.

Each of the steps depicted in the flow diagrams presented herein can itself include a sequence of operations that need not be described herein. Those skilled in the relevant art can create routines, algorithms, source code, microcode, program logic arrays or otherwise implement the invention based on the flow diagrams and the detailed description provided herein. The routines described herein can be provided with one or more of the following, or one or more combinations of the following: stored in non-volatile memory (not shown) that forms part of an associated processor or processors, or implemented using conventional programmed logic arrays or circuit elements, or stored in removable media such as disks, or downloaded from a server and stored locally at a client, or hardwired or preprogrammed in chips such as EEPROM semiconductor chips, application specific integrated circuits (ASICs), or by digital signal processing (DSP) integrated circuits.

Unless described otherwise herein, the information described herein is well known or described in detail in the above-noted and cross-referenced provisional patent applications. Indeed, much of the detailed description provided herein is explicitly disclosed in the provisional patent applications; most or all of the additional material of aspects of the invention will be recognized by those skilled in the relevant art as being inherent in the detailed description provided in such provisional patent applications, or well known to those skilled in the relevant art. Those skilled in the relevant art can implement aspects of the invention based on the material presented herein and the detailed description provided in the provisional patent application.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” and words of similar import, when used in this application, shall refer to this application as a whole and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other machine vision systems, not only for the data collection symbology reader described above. Further, the elements and acts of the various embodiments described above can be combined to provide further embodiments.

All of the above references and U.S. patent applications are incorporated herein by reference. Aspects of the invention can be modified, if necessary, to employ the systems, functions and concepts of the various references described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all speech signal systems that operate under the claims to provide a method for procurement. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. Thus, the inventors reserve the right to add additional claims after filing the application to pursue such additional claim forms for other aspects of the invention.

What is claimed is:

1. A method for generating a pulsed excitation function representative of a human vocal tract, comprising:
receiving movement information of at least one tissue type associated with human voicing activity, wherein the movement information comprises position versus time information, wherein the at least one tissue type includes human tissue that vibrates with opening and closing of vocal folds;
generating pressure information using at least one derivative of the movement information;
identifying opening times and closing times of the vocal folds using the pressure information;
constructing the pulsed excitation function by generating a curve including negative amplitude pulses at times corresponding to the closing times and positive amplitude pulses at times corresponding to the opening times; and
adjusting amplitudes and widths of the negative amplitude and positive amplitude pulses to match speech output of the human vocal tract.

2. The method of claim 1, further comprising:
determining parameters of the human vocal tract by applying a simple harmonic oscillator model to the constructed pulsed excitation function, wherein the parameters include mass, elasticity, and damping; and
constructing a model of the human vocal tract using the parameters.

3. The method of claim 1, further comprising determining voiced speech parameters using the constructed pulsed excitation function, wherein the human speech parameters include voiced excitation functions, voicing states, pitch periods, vocal tract transfer functions, and tracheal wall parameters.
